(19) United States
(12) Patent Application Publication
(10) Pub. No.: US 2009/0044449 A1
(43) Pub. Date: Feb. 19, 2009

(54) MOTOR-OPERATED COMPONENT WITH ANTI-TRAPPING MEANS

(75) Inventors: Josef Appel, Gauting (DE); Anton Dietmar Johl, Bad Heilbrunn (DE)

Correspondence Address: DICKINSON WRIGHT PLLC, 1875 Eye Street, NW, Suite 1200, WASHINGTON, DC, 20006, US

(73) Assignee: WEBASTO AG, Stockdorf (DD)

(21) Appl. No.: 12/281,525

(22) PCT Filed: Mar. 1, 2007
(86) PCT No.: PCT/DE2007/000375

§ 371 Date: Sep. 3, 2008

(30) Foreign Application Priority Data
Mar. 3, 2006 (DE) 10 2006 009 998.2

(51) Int. Cl. E05F 15/10

(52) U.S. Cl. 49/28; 49/502

(57) ABSTRACT

The present invention relates to a motor-operated component, in particular in or for a motor vehicle, which comprises at least in regions a material which is permeable to an electric field, and which comprises a sensor-controlled anti-trapping apparatus which contains at least one electrically conductive first sensor electrode which is arranged in the interior of the component in a region which comprises the material which is permeable to electric fields, and which is inaccessible from outside the component.

The present invention relates to a motor-operated component, in particular in or for a motor vehicle, which component has an anti-trapping means.

### TECHNICAL BACKGROUND

Components which can be adjusted by motor in a motor vehicle are movable devices, such as sliding roofs, tilting roofs, side doors, sliding doors and tailgates. The invention and the problems on which it is based will be described in the following text in relation to an anti-trapping means in a tailgate of a motor vehicle, without restricting the invention thereto, however.

A motor drive is designed in a tailgate of this type to move the latter out of a closed into an open position and vice versa. During a closing operation, a trapping case can occur, in which, for example, a hand of a person can pass into the gap between the tailgate and the vehicle body. In order to detect in time situations of this type which frequently lead to injuries and therefore in order to avoid them, electrically actuable components have safety systems. Said safety systems can be divided into systems which operate directly and those which operate directly.

In a system which operates indirectly, an imminent dangerous situation which can possibly lead to trapping is detected at an early stage and the attention of the corresponding operator is drawn to this dangerous situation by means of a warning signal which is, for example, acoustic. A safety system which operates directly has, as a rule, sensors which, for example, detect a hand of a person which is situated in the region between the tailgate and the vehicle body and, in the case of a detected dangerous situation of this type, stop the motor drive for closing the tailgate immediately or reset the tailgate into a position which is safe in relation to trapping.

Safety systems of this type for providing anti-trapping protection exist in a multiplicity of different embodiments and variants which differ from one another substantially in the type of detection of a dangerous situation. In the automotive field, safety systems for providing anti-trapping protection frequently have proximity sensors which work capacitively, in the case of motor-operated components. The capacitive sensor electrodes are typically integrated here into corresponding rubber profiles of the tailgate which are attached along the clamping edge on the tailgate or the corresponding opposite edge on the vehicle body.

Attaching said sensor electrode to the tailgate is relatively complicated in terms of assembly technology and additionally frequently influences the design of the tailgate in an undesirable manner. It is often desirable for design reasons to provide a smooth surface which is visually as uniform as possible and is therefore attractive, in particular at the edge of the tailgate, in which no sensor electrode is visible. In addition, it is complicated for reasons of manufacturing technology to integrate the corresponding sensor electrodes, for example, into the rubber profile of the edge of the tailgate.

German patent application DE 103 28 929 A1 and German patent application DE 40 04 353 A1 describe in each case anti-trapping protection devices, in particular for use for window lifters in a motor vehicle, with the use of capacitive sensors.

Against this background, it is the object of the present invention to provide an anti-trapping means which can be manufactured simply for a motor-operated component.

### SUMMARY OF THE INVENTION

According to the invention, this object is achieved by a component having the features of patent claim 1.

Accordingly, a motor-operated component is provided, in particular in or for a motor vehicle, which motor-operated component has, at least in regions, a material which is permeable for an electromagnetic field, and which motor-operated component has a sensor-controlled apparatus for protecting against trapping which comprises at least one electrically conductive first sensor electrode which is arranged in the interior of the component in a region which has a material, which is permeable for electric fields, and is inaccessible from an outer side of the component.

The concept on which the present invention is based comprises arranging the sensor electrode of a sensor-controlled anti-trapping apparatus in the material or within the motor-operated component such that it is inaccessible from the outside. It is essential here that the motor-operated component is at least partially permeable for an electric field at least in that region, in which the sensor electrode is arranged. The finding of the present invention comprises the fact that, in an embodiment of a component of this type with a material which is permeable for an electric field, it is not required to arrange the sensor electrodes on the outer surface of the motor-operated component, since precisely this material is permeable for electric fields and therefore the sensor electrode also remains functional within the component. Rather, for an anti-trapping means using a capacitive sensor system, it is advantageous to integrate the required sensor electrode into the material of the motor-operated component itself or to attach it to an inner side of the component.

In this way, sensor parts and their fastening means can be designed very much less expensively than is required in the case of conventional anti-trapping apparatuses, in which the sensor electrode is arranged on the outer surface of the component. Since, in addition, no visible parts are required here for the sensor electrode and its fastening means, the sensor electrodes and their fastening means, for example their carrier plates, can be configured less expensively. Since, in addition, these regions are not accessible from the outside and therefore are virtually not loaded mechanically, less high quality materials are required for the sensor parts and their fastening means.

In addition, above all the mounting of the sensor electrodes and their supply lines is also designed significantly more simply and above all more quickly, since less precise manufacturing is required here for design reasons (they are not visible parts). In particular, no mounting operations are required either on the vehicle body itself, since the sensor electrodes can already be manufactured and delivered with the material of the motor-operated component, for example by a supplier.

A further aspect which is not insubstantial results from the fact that the sensor electrodes are then no longer visible from the outside and the design is therefore not influenced by the sensor electrode. Greater degrees of freedom in the design of the motor-operated component therefore advantageously result.

Moreover, the sensor electrode is less susceptible to corrosion, since it is arranged in the interior of the component in a manner which is protected against internal influences and, in particular, against moisture.

Advantageous refinements and developments of the invention result from the further subclaims and from the description in conjunction with the drawings.

In one preferred refinement, the anti-trapping apparatus has a contactless proximity sensor. This proximity sensor is preferably a sensor which operates capacitively. Other contactless proximity sensors would also be conceivable here, for example on the basis of infrared, ultrasound or radar.

In one typical refinement, the proximity sensor has at least one first sensor electrode which is arranged within the component. Furthermore, the proximity sensor can have at least one second sensor electrode which is arranged so as to lie substantially opposite the first sensor electrode when the component is closed. This second sensor electrode is situated, for example, in a rigid vehicle body part of the motor vehicle.

The first sensor electrode is preferably arranged in a region of the motor-operated component, the outer face of which is accessible from the outside only in the open state of the component. In the case of a sliding door, a side door or a tailgate of a motor vehicle, this is, for example, the edge face between the inner trim and the outer face of said components, in which edge face the closure mechanism of the door or the gate is also provided.

In particular, the first sensor electrode is preferably arranged in the interior of the motor-operated component along its edge at risk of trapping. The arrangement of a sensor electrode for the anti-trapping means in this region is most effective, since a situation which is dangerous for trapping and could possibly lead to undesired trapping can best be detected prematurely there.

The first sensor electrode is expediently arranged in the region of the component which has the material which is permeable for the electric field or which is enclosed completely by the material of said component and is inaccessible from the outside.

The motor-operated component typically has an outer face which is accessible from the outside in the open state of the component. Furthermore, said component has an inner face which is provided on a side of the component which faces away from the outer face, the sensor electrode being arranged on the inner face of the component.

In addition or as an alternative, the sensor electrode can also be formed by an electrically conductive region within the material itself which is permeable for electric fields. This variant provides the use of multiple-component, customarily not conductive materials, for example plastics, in which one region which is to form the sensor electrode is made conductive by adding electrically conductive materials.

In one refinement of the invention, the sensor electrode is configured as a conductive coating and/or as a conductive wire electrode and/or as a conductive sheet metal part and/or as a conductive (metal) foil. This type of sensor electrode can be integrated into the material of the component, for example by injection molded encapsulation. In addition or as an alternative, it would also be conceivable to arrange the sensor electrode on the inner face of the component.

In one preferred refinement, the sensor electrode is fastened onto the inner face of the component by means of an adhesive layer and/or by means of a clip closure and/or by means of a screw connection.

In an alternative refinement to above, the sensor electrode can be embossed or pressed into the material of the component. As an alternative, it would also be conceivable, in particular in a refinement of the sensor electrode as a coating, to vapor-deposit it directly onto the inner face.

In one particularly preferred refinement, the material which is permeable for electric fields is configured as plastic. Preferred plastic materials are those which are used anyway in the automotive field and which therefore have high stability and, in addition, temperature resistance.

In one typical refinement, the motor-operated component is configured as a tailgate or as a trunk lid, which can be operated via an electric motor drive. Further applications are, for example, electric sliding doors, side doors, sliding and/or tilting roofs of a motor vehicle and the like.

In one typical refinement, the anti-trapping apparatus has a control device. Said control device which typically also comprises an evaluation circuit for evaluating the sensor signals controls the anti-trapping means as a function of the evaluation of the sensor signals.

The control device is typically but not necessarily arranged within the motor-operated component. Here, the control device can likewise be arranged on the inner face of the component. As an alternative, it would also be conceivable to integrate the control device in that material of the component itself which is permeable for the electric field.

In one preferred refinement, the control device is attached without the provision of a shielding means on the side of the first sensor electrode. An associated evaluation circuit can therefore be attached directly to the first sensor electrode, which makes it possible to dispense with complicated cabling which is protected against electromagnetic signals. In this way, the control device and the evaluation circuit which is arranged in it are likewise accommodated in a protected manner in the interior of the component, like the corresponding sensor electrode. Cable leadthroughs from the outer side of the component to the inside or a housing guide which is particularly resistant to environmental influences can therefore be omitted.

In one particularly advantageous development, the control device and, in particular, its contact connections to the sensor electrode here are connected to said first sensor electrode via a flat contact, for example on a printed circuit board. Particularly elegant connection of the sensor electrode and the control device can therefore be brought about, any contact resistances which are present and are very low here being tolerable here, since the low coupling capacitance between the control device and the sensor electrode is already sufficient for providing a functional connection between the sensor electrode and the evaluation circuit.

In one preferred development, the control device is a constituent part of a control unit for controlling the opening and/or closing operation of the component.

The component is typically provided with a drive motor which moves the motor-operated component as a function of a control operation of the control device. The drive motor acts on an adjusting mechanism for an opening and/or closing operation of the component, the component preferably being connected to this adjusting mechanism via a driver.

### CONTENTS OF THE DRAWING

In the following text, the invention will be explained in greater detail using the exemplary embodiments which are shown in the diagrammatic figures of the drawings, in which:

FIG. 1A shows a side illustration of a tailgate according to the invention of a motor vehicle with an anti-trapping means;

FIG. 1B shows a frontal illustration of the tailgate according to the invention from FIG. 1A;

FIG. 2 shows a detailed illustration of the tailgate according to the invention of FIGS. 1A and 1B in cross section; and

FIGS. 3-8 show detailed illustrations of different embodiments for the arrangement of a sensor electrode within a tailgate according to the invention.

In the figures of the drawings, identical and functionally identical elements are provided with the same designations, as long as nothing else is specified.

### DESCRIPTION OF EXEMPLARY EMBODIMENTS

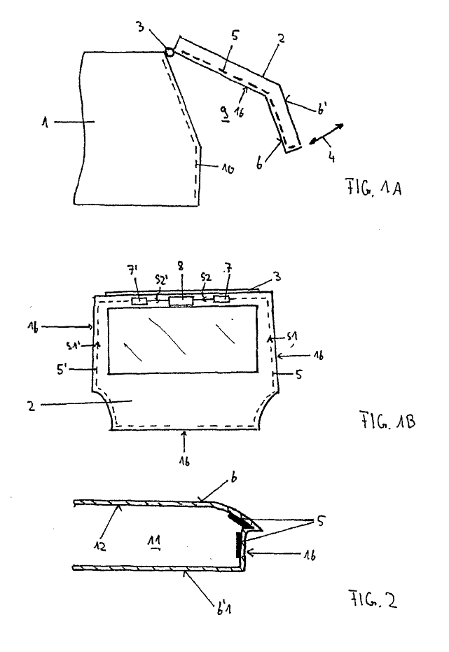

FIGS. 1A and 1B use a diagrammatic side illustration and a frontal illustration, respectively, to show a tailgate 2 which is attached to a motor vehicle 1 which is shown only in part. The tailgate 2 can be moved open and closed in the pivoting direction 4 via a rotational pin 3 which is provided on the roof of the motor vehicle 1. For this purpose, a motor drive (for example, of a drive motor) is provided which operates the tailgate by motor via an adjusting mechanism (not shown in FIGS. 1A and 1B). Depending on the rotational direction of the motor drive, an opening operation or a closing operation in each case in the pivoting directions 4 can therefore be realized. This opening and closing of the tailgate 2 which is operated via the drive motor can be realized in a wide variety of embodiments and variants, for example by direct intervention of the drive on the rotational pin 3 or, as an alternative, by means of a lever driver which is attached on the tailgate 2 and the motor vehicle 1 and is operated via the drive. However, the design of said drive motor with an adjusting mechanism is not discussed in greater detail in the present patent application.

According to the invention, at least one sensor electrode 5 according to the invention is integrated within the tailgate 2. This sensor electrode 5 is a constituent part of a capacitive proximity sensor. It is essential that this sensor electrode 5 is arranged in the interior of the tailgate 2, that is to say in any case not on a surface 6 of the tailgate 2 which is accessible from the outside. Furthermore, it is essential that there is a material of the tailgate 2 which is permeable for an electric field in the region, in which the sensor electrode 5 is arranged within the tailgate 2. It is to be assumed in the present exemplary embodiment that the tailgate 2 is composed of plastic. As an alternative, it would also be conceivable for the tailgate 2 to be composed of plastic in the region of the surface 6 which is directed toward the rear of the vehicle, whereas the tailgate 2 is composed of another material, for example of sheet metal, in the surface 6′ which faces away from the rear of the vehicle.

FIG. 1B shows a plan view of the tailgate 2. Two different sensor electrodes 5, 5′ are provided here which are arranged substantially in the outer region of the tailgate 2, that is to say in that region of the tailgate 2 which is at risk of trapping. The sensor electrodes 5, 5′ which are, for example stripe-shaped are arranged within the tailgate 2 here, which has been indicated by the dashed lines. In the upper region of the tailgate 2, two evaluation units 7, 7′ are provided which are connected in each case to one of the sensor electrodes 5, 5′. Said evaluation units 7, 7′ are designed to perform an evaluation of the sensor signals S1, S1′ which are generated by the sensor electrodes 5, 5′. As a function of this evaluation, the evaluation units 5, 5′ generate corresponding evaluation signals S2, S2′ which are fed to a corresponding control device 8. The control device 8 is designed to control the opening and closing operations of the tailgate 2. In the case of a dangerous situation, in which, for example, trapping is imminent in a gap 9 between the tailgate and the motor vehicle 1, this is detected by means of at least one of the evaluation units 7, 7′ and the control device is informed correspondingly by the control signals 2, 2′. The control device 8 is therefore capable of activating an anti-trapping means, for example by the tailgate 2 being opened again or at least the closing operation being stopped if the tailgate 2 is being closed.

It goes without saying that the evaluation units 7, 7′ can also be integrated into the control device 8.

The control device 8 can be configured, for example, as a program-controlled device, for example as a microcontroller or microprocessor, and is typically a constituent part of a control unit. This control unit is typically assigned the function for controlling the opening and closing operations of the tailgate.

Moreover, the control unit preferably also comprises the function for controlling the anti-trapping means.

FIG. 2 shows a tailgate 2 having a sensor electrode 5 according to the invention in detail. In addition, a further sensor electrode 10 can also be arranged in the region of the motor vehicle 1, for example in the rear region of the vehicle body of the motor vehicle 1 which immediately adjoins the region 9 which is at risk of trapping.

The tailgate 2 is manufactured from a thin-walled plastic part which is shaped in such a way that it defines a closed interior 11 of the tailgate 2. The tailgate 2 therefore has outer faces 6, 6′ which are accessible from the outside. Inner surfaces 12 which are not accessible from the outside are formed in the interior 11 of the tailgate 2. According to the invention, the sensor electrode 5 is arranged on the inner surface 12 of the tailgate 2 which comprises plastic. Since plastic is permeable for an electric field, the proximity sensor 5 which is, for example, capacitive remains functional even if it is arranged within the tailgate 2, as is shown in FIG. 2.

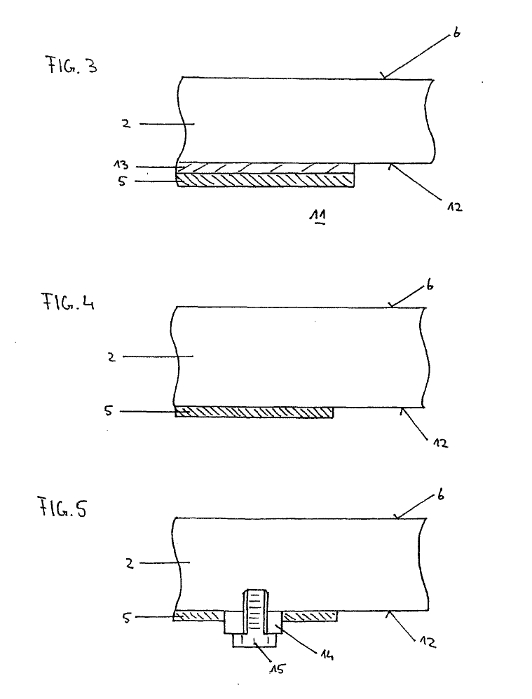

Some exemplary embodiments for the arrangement of the sensor electrodes 2 in the interior of the tailgate or its material are shown merely by way of example, that is to say not in a restrictive way, using the following detailed illustrations in FIGS. 3 to 8:

FIG. 3 shows a detail of a tailgate 2 which comprises plastic and has an outer surface 6 and an inner surface 12. A sensor electrode 5 is arranged on the inner surface 12, as has already been described in FIG. 2. The sensor electrode 5 can be configured as a conductive wire, as a metal sheet or the like. The sensor electrode 5 is connected to the tailgate 2 via an adhesive layer 13.

In the exemplary embodiment which is shown in FIG. 4, the sensor electrode 5 is applied as a coating directly to the inner surface 12. The conductive coating can be produced, for example, by vapor-depositing conductive material onto the inner surface 12, conductive materials such as aluminum, copper, zinc, tungsten, silver, etc. or alloys of said materials being preferably suitable here.

In the exemplary embodiment in FIG. 5, a fastening bracket 14 is provided which surrounds and therefore fixes the sensor electrode on the side of the inner surface 12. For fastening purposes, a screw 14 is provided, for example a selftapping screw, which fastens the fastening bracket 14 and therefore also the sensor electrode 5 to the tailgate 2, for example by the selftapping screw 15 cutting into the plastic material of the tailgate 2.

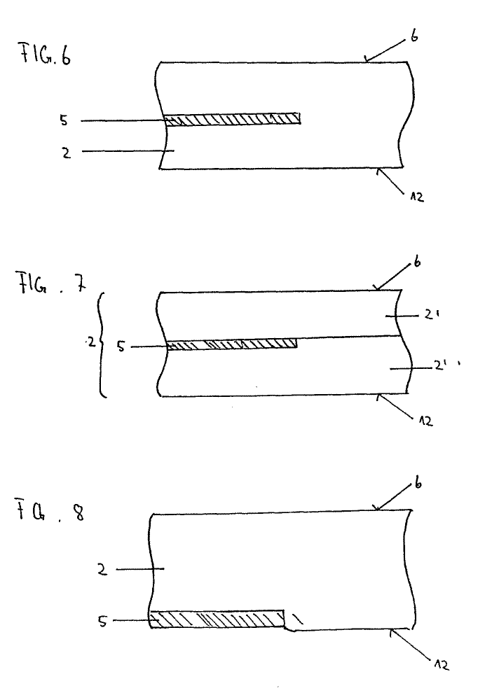

In all the exemplary embodiments of FIGS. 3 to 5, the sensor electrode 5 is arranged in the interior 11 of the tailgate 2, to be precise on the inner surface 12 of the tailgate 2. In contrast to this, in the following exemplary embodiments of FIGS. 6 to 8, the sensor electrodes 5 which are shown there are arranged within the material of the tailgate 2.

In the exemplary embodiment which is shown in FIG. 6, the sensor electrode 5 which is configured, for example, as a metal sheet or a conductive wire is arranged completely in the material of the tailgate 2 which comprises, for example, plastic. For production, the sensor electrode 5 is positioned, for example, in an injection molding die which is provided solely for this purpose. The tailgate 2 with the sensor electrode 5 integrated into it is produced by injection molding encapsulation with plastic.

In the exemplary embodiment which is shown in FIG. 7, the tailgate 2 and the sensor electrode 5 which is arranged in it are composed of the same material, for example of plastic. A conductive material is added to the plastic in the region of the sensor electrode 5, so that the conductive sensor electrode 5 is formed as a result. This can be produced, for example, by stepped injection molding of the tailgate 2, by, for example, first of all the region 2′ of the outer surface 6 of the tailgate 2 being produced, subsequently the laminar sensor electrode 5 being produced by addition of a conductive material to the plastic, and subsequently those regions 2″ of the tailgate 2 which adjoin the inner surface 12 being produced.

In the exemplary embodiment which is shown in FIG. 8, the sensor electrode 5 which is configured, for example, from sheet metal or wire is pressed or embossed into the material of the tailgate 2 from the inner surface 11. This preferably takes place in heated surroundings which soften the material of the tailgate 2 to a certain extent and thus make embossing or pressing of the sensor electrode 5 into the material of the tailgate 2 easier. As shown in FIG. 8, the sensor electrode 5 can be pressed completely into the material of the tailgate 2 or else have a certain projection beyond the inner surface 11.

Although the present invention has been described in the preceding text using preferred exemplary embodiments and variants, it is not restricted thereto, but can of course be amended and modified in any desired way. In particular, the invention is not restricted to the concrete embodiments of the sensor electrode and the materials which are used for the sensor electrode and for the tailgate. Any other material than plastic can be used as tailgate material, which material has the property of being at least partially permeable for electric and/or electromagnetic fields. Any material or object which is electrically conductive can be used as sensor electrode, materials of the type preferably being used which can be processed very simply in terms of manufacturing technology and can be attached simply to the tailgate in terms of mounting technology.

Although it is preferred to mount the sensor electrode in the outer regions of the tailgate which are at risk of trapping, the sensor electrodes could also be arranged at any other points of the tailgate which make defined evaluation possible for the anti-trapping means.

A sensor of such a type that emits and/or receives and evaluates electromagnetic signals can also be used as sensor electrode.

The invention is also not restricted exclusively to a tailgate in a motor vehicle, but can of course also be applied to other motor-operated components, such as side doors, sliding/tilting roof constructions, trunk lids and the like. Moreover, the invention is not restricted exclusively to the automotive field, but can also be used advantageously in other vehicles, such as trucks, buses, train cars and the like.

The drive motor system and adjusting motor system described in the patent application are to be understood only by way of example, but can be modified as desired, without an inventive step being involved to this end.

### LIST OF DESIGNATIONS

1 Motor vehicle
2 Tailgate
2′, 2″ Regions of the tailgate
3 Rotational pin between the tailgate and the motor vehicle
4 Pivoting directions
5, 5′ Sensor electrodes, capacitive proximity sensors
6, 6′ Outer faces of the tailgate
7, 7′ Evaluation units
8 Control device
9 Region at risk of trapping, gap
10 Second sensor electrode in the region of the vehicle body
11 Interior of the tailgate
12 Inner faces
13 Adhesive layer
14 Fastening bracket
15 Screw
16 Edge at risk of trapping
S1, S1′ Sensor signals
S2, S2′ Evaluation signals

1. A motor-operated component, in particular in or for a motor vehicle,
which motor-operated component has, at least in regions, a material which is permeable for an electric field, and
which motor-operated component has a sensor-controlled anti-trapping apparatus which comprises at least one electrically conductive first sensor electrode which is arranged in the interior of the component in a region which has a material, which is permeable for electric fields, and is inaccessible from an outer side of the component.

2. The component of claim 1, characterized in that the anti-trapping apparatus has a contactless proximity sensor, in particular a capacitive sensor.

3. The component of claim 2, characterized in that the proximity sensor has at least one first sensor electrode which is arranged within the component and at least one second sensor electrode which is arranged so as to lie substantially opposite the first sensor electrode when the component is closed.

4. The component of claim 1, characterized in that the first sensor electrode is arranged in a region of the component, the outer face of which is accessible from the outside only in the open state of the component.

5. The component of claim 1, characterized in that the first sensor electrode is arranged in the interior of the component along its edge at risk of trapping.

6. The component of claim 1, characterized in that the first sensor electrode is arranged in a region of the component which has the material which is permeable for the electric field.

7. The component of claim 1, characterized in that the component has an outer face which is accessible from the outside in the open state of the component and an inner face which is provided on a side of the component which faces away from the outer face, the first sensor electrode being arranged on the inner face of the component.

8. The component of claim 1, characterized in that the first sensor electrode is formed by an electrically conductive region within that material of the component which is permeable for electric fields.

9. The component of claim 1, characterized in that the sensor electrode is configured as a conductive coating and/or as a conductive wire electrode and/or as a conductive foil and/or as a conductive sheet metal part.

10. The component of claim 1, characterized in that the sensor electrode is fastened on an inner face of the component by means of an adhesive layer and/or by means of a clip closure and/or by means of a screw connection.

11. The component of claim 1, characterized in that the sensor electrode is embossed and/or pressed into an inner face of the component and/or is vapor-deposited directly onto an inner face of the component.

12. The component of claim 1, characterized in that that material of the component which is permeable for electric fields is plastic.

13. The component of claim 1, characterized in that the component is configured as a tailgate, as a trunk lid, as a sliding door, as a side door and/or as a tilting/sliding roof of a motor vehicle.

14. The component of claim 1, characterized in that the anti-trapping apparatus has a control device which evaluates sensor signals of the sensor electrode and controls the means for protecting against trapping as a function of the evaluation.

15. The component of claim 14, characterized in that the control device is arranged within the component.

16. The component of claim 14, characterized in that the control device is arranged on an inner face of the component and/or in that material of the component which is permeable for the electric field.

17. The component of claim 14, characterized in that the control device is attached without shielding on the side of the first sensor electrode.

18. The component of claim 14, characterized in that the control device is connected to the first sensor electrode via a flat contact.

19. The component of claim 14, characterized in that the control device is a constituent part of a control unit for controlling the opening and/or closing operation of the component.

20. The component of claim 14, characterized in that the motor-operated component moves as a function of a control operation of the control device, the drive motor acting on an adjusting mechanism for an opening and/or closing operation of the component, and the component being connected to this adjusting mechanism via a driver.
